(19) United States
(12) Patent Application Publication
(10) Pub. No.: US 2026/0336597 A1
(43) Pub. Date: Oct. 29, 2026

(54) METHOD AND CONTROL ARRANGEMENT FOR STARTING AN INTERNAL COMBUSTION ENGINE

(71) Applicant: Scania CV AB, Södertälje (SE)

(72) Inventors: Daniel STÅHL, Enköping (SE); Martin BERGLUND, Vagnhärad (SE); Erik KILSAND, Saltsjö-Boo (SE); Oscar FLÄRDH, Älvsjö (SE)

(73) Assignee: Scania CV AB, Södertälje (SE)

(21) Appl. No.: 19/482,875

(22) PCT Filed: May 8, 2024
(86) PCT No.: PCT/SE2024/050439

§ 371 Date: Nov. 10, 2025

(30) Foreign Application Priority Data
May 17, 2023 (SE) 2350600-9

(51) Int. Cl. B60W 20/15; B60W 10/02; B60W 10/06; B60W 10/08; B60W 20/40; F02D 41/06; F02D 41/30; F02N 11/08

(52) U.S. Cl. CPC B60W 20/15; B60W 10/02; B60W 10/06; B60W 10/08; B60W 20/40; F02D 41/062; F02D 41/3005; F02N 11/0851; B60W 2530/10

(57) ABSTRACT

The present invention relates to a method for starting an internal combustion engine in an electric hybrid vehicle. The method comprises, for at least one first vehicle driving condition, when the internal combustion engine is disconnected from the at least one first drive wheel, and is to be started when the vehicle is in motion: accelerating the internal combustion engine using drive wheel torque by partially closing the clutch to connect the internal combustion engine to the at least one first drive wheel, applying a vehicle propelling torque by the electric machine while accelerating the internal combustion engine, so as to at least partly compensate for drive wheel torque being used to accelerate the internal combustion engine, and commencing fuel injection to start the internal combustion engine. The invention also relates to a control arrangement, a computer program, a computer-readable medium and a vehicle comprising a control arrangement.

### TECHNICAL FIELD

The invention relates to a method and a control arrangement for starting an internal combustion engine. The invention also relates to a computer program, a computer-readable medium and a vehicle comprising a control arrangement.

### BACKGROUND

The following background description does not necessarily constitute prior art.

Electric hybrid vehicles, in general, comprise an internal combustion engine, as well as one or more electric machines for providing propelling torque/power to be used in the propulsion of the vehicle. The use of one or more electric machines in the vehicle drivetrain allows that, in addition to, e.g., improved fuel consumption performance, various further features may be implemented in the vehicle. For example, when the vehicle is traveling downhill, or otherwise with a reduced request for propelling power, the internal combustion engine may, at least for some configurations, be shut off to allow the one or more electric machines to assume responsibility for the propulsion of the vehicle.

In case a need for propelling power from the internal combustion engine again arises, the internal combustion engine may be started to resume participation in the propulsion of the vehicle. In addition to saving fuel, the shutting off of the internal combustion engine may also improve driver comfortability, e.g., due to reduced vibrations and noise.

### SUMMARY

It is an objective of the invention to provide a method and a control arrangement for mitigating or solving drawbacks of conventional solutions. In particular, an object of the invention is to provide a method performed by a control arrangement for starting an internal combustion engine in an electric hybrid vehicle in a situation where the vehicle is motion, where the start is carried out in a manner that may increase vehicle stability and/or driver comfortability.

According to a first aspect of the invention, the aforementioned and further objects are achieved through a method performed by a control arrangement for starting an internal combustion engine in an electric hybrid vehicle, the internal combustion engine being configured for applying a propelling torque to at least one first drive wheel of the vehicle, the vehicle comprising:
a clutch selectively connecting an output shaft of the internal combustion engine to the at least one drive wheel of the vehicle,
an electric machine for applying a propelling torque to the at least one first or at least one second drive wheel of the vehicle,
the method comprising, for at least one first vehicle driving condition, when the internal combustion engine is disconnected from the at least one first drive wheel, and is to be started when the vehicle is in motion:
accelerating the internal combustion engine using drive wheel torque by partially closing the clutch to connect the internal combustion engine to the at least one first drive wheel,
applying a vehicle propelling torque by the electric machine while accelerating the internal combustion engine, so as to at least partly compensate for drive wheel torque being used to accelerate the internal combustion engine, and
commencing fuel injection to start the internal combustion engine.

As was mentioned above, the internal combustion engine in a hybrid vehicle may be shut off during driving to improve, e.g., fuel efficiency, and this may also increase driver comfortability. The internal combustion engine may be shut off, e.g., by stopping fuel injection and disconnecting the internal combustion engine from the drive wheels by the opening of a clutch. As was also mentioned, the internal combustion engine may again be started when required to provide propulsion power. However, the actual start of the internal combustion engine may, in itself, give rise to various drawbacks. For example, when the internal combustion engine is to be started from a state in which it has been shut off, this may give rise to vibrations and possibly a jerky behavior of the vehicle which not only may be perceived as uncomfortable by the driver but, perhaps more importantly, which may also give rise to potentially hazardous situations, in particular when the friction between the vehicle wheels and the surface upon which the vehicle is traveling is reduced.

Vibrations during the start of the internal combustion engine is in general at least partly a result of fuel injection being commenced at a relatively low speed of rotation of the internal combustion engine during the start. Jerky behaviour, and potentially hazardous situations, on the other hand, may arise principally as a result of the method of starting the internal combustion engine. Oftentimes a clutch interconnecting the internal combustion engine to the vehicle drive wheels is used to accelerate the internal combustion engine during engine start instead of using a starter motor when the vehicle is in motion. As was mentioned, the internal combustion engine may be shut off by stopping fuel injection and opening the clutch to allow the speed of rotation of the internal combustion engine to reduce to zero.

When the internal combustion engine subsequently is to be started again, this may be accomplished by at least partially closing the clutch to thereby accelerate the internal combustion engine using torque provided by the vehicle drive wheels, and subsequently commence fuel injection. This, however, has the drawback that the closing of the clutch consumes drive wheel torque, with the effect that the drive wheels are subjected to a corresponding brake torque, or change in torque in case the drive wheels are already subjected to a propelling torque or brake torque. This torque change, which may be sudden, may give rise to vehicle instability, e.g., when the prevailing road friction is reduced, and perhaps in particular when travelling downhill and/or on a curvy road in slippery road conditions.

According to the first aspect of the invention it is provided a solution that at least reduces problems of this kind. According to the invention, the clutch is still used to provide drive wheel torque to accelerate the internal combustion engine during engine start in a situation where the vehicle is in motion. However, in addition to accelerating the internal combustion engine using drive wheel torque the method comprises, for at least one first vehicle driving condition, applying a vehicle propelling torque by the electric machine while accelerating the internal combustion engine using the clutch.

In this way, drive wheel torque that is consumed by the internal combustion engine during engine acceleration, and that hence thereby may potentially negatively affect the vehicle stability, is at least partly compensated for by a counteracting, i.e., in this case vehicle propelling, torque being applied by the electric machine. The negative impact on the drive wheel torque caused by the closing of the clutch may thereby partly or fully be compensated for by applying torque using the electric machine. This may, for example, increase safety when starting the internal combustion engine using the clutch in slippery conditions. This may also provide for a more rapid start of the internal combustion engine. Also, the compensating torque may allow a higher torque to be transmitted by the clutch. It is in general the case that a fast closing of the clutch is preferrable from a wear point of view, but this may also give to rapid changes of drive wheel torque with the above drawbacks. This may hence be mitigated by the compensating torque provided by the electric machine. According to various aspects of the invention, further possible advantages may also be provided.

According to another aspect of the invention, the method further comprises commencing the applying of torque to the internal combustion engine by means of a starter motor prior to partially closing the clutch to connect the internal combustion engine to the at least one first drive wheel, and commencing fuel injection prior to or following the clutch partially being closed.

In this way, the acceleration of the internal combustion engine may be commenced using the starter motor prior to partially closing the clutch, and thereby partly accelerate the internal combustion engine prior to applying torque using the clutch. This will result in a reduced difference in speed of rotation between the clutch plates, which thereby may reduce clutch wear. This may also reduce the initial brake torque that the drive wheels are subjected to when the internal combustion engine is set in rotation.

According to aspects of the invention, the starter motor is only used to apply torque to the internal combustion engine in situations where the internal combustion engine is not rotating. Hence such a determination may be made prior to activating the starter motor. This may ensure that the starter motor is not unnecessarily subjected to wear by attempting use in a situation when the internal combustion engine has not fully stopped when it is again to be started.

According to aspects of the invention, the fuel injection for starting the internal combustion engine is commenced when the speed of rotation of the internal combustion engine has reached a first speed of rotation. This may reduce vibrations that may arise in particular in situations when fuel injection is commenced at low speeds of rotation of the internal combustion engine.

According to aspects of the invention, the clutch is maintained partially closed until the speed of rotation of the output shaft of the internal combustion engine corresponds to a predetermined speed of rotation, where the predetermined speed of rotation is a speed of rotation below the speed of rotation of the clutch caused by the at least one first drive wheel. The clutch is opened when the predetermined speed of rotation has been reached. This may provide for reduced wear on the clutch, since the clutch need not be used throughout the start of the internal combustion engine but, instead, the internal combustion engine may complete the start through the fuel injection.

The predetermined speed may also be determined as a speed at which it is estimated that the clutch is to begin to be opened in order to allow the actual speed of rotation of the internal combustion engine to reach a desired speed prior to the opening of the clutch has been fully completed, since the internal combustion engine will continue to accelerate by drive wheel torque during the time it takes to fully open the clutch.

However, according to aspects of the invention, the clutch is maintained partially closed until the speed of rotation of the output shaft of the internal combustion engine corresponds to the speed of rotation of the clutch caused by the at least one first drive wheel. That is, the speed of rotation that corresponds to the synchronous speed of the internal combustion engine. It is hence possible to utilize the clutch for acceleration of the internal combustion engine throughout the acceleration to the synchronous speed to thereby reduce, e.g., vibrations.

According to aspects of the invention, the vehicle propelling torque is applied by the electric machine while the clutch is partially closed. The vehicle propelling torque may hence be configured to be applied throughout the time the clutch is partially closed to thereby compensate for drive wheel torque being consumed throughout the start of the internal combustion engine.

According to aspects of the invention, the electric machine is configured to apply the vehicle propelling torque to a shaft being propelled by the internal combustion engine when connected to the at least one first drive wheel by means of the clutch. The electric machine may hence be configured to only provide a compensating torque while the internal combustion engine is actually connected to at least one drive wheel to receive accelerating torque. Furthermore, the electric machine may be configured to be selectively connectable to a drive shaft connecting the internal combustion engine to the at least one first drive wheel through a second clutch, and the method may comprise to close the second clutch when applying torque by means of the electrical machine. The electric machine may, e.g., be connected to a layshaft of a gearbox, or downstream the gearbox.

According to aspects of the invention, the electric machine may be configured to apply the vehicle propelling torque to at least one drive wheel being different from the at least one first drive wheel that is used to accelerate the internal combustion engine. It is hence not required that the electric machine provides torque to the same wheel shaft that is used to accelerate the internal combustion engine. Still, advantages in the form of, e.g., reduced vibrations and increased driver comfortability may be obtained.

According to aspects of the invention, the vehicle further comprises a gearbox connecting the internal combustion engine to the at least one first drive wheel. The presence of a gearbox is very common with regard to vehicles comprising an internal combustion engine, and according to aspects of the invention the internal combustion engine is accelerated through partial closing of the clutch when a gear is engaged in the gearbox.

According to aspects of the invention, the rate at which, and/or the degree to which, the clutch is closed during the acceleration of the internal combustion engine is at least partly based on the prevailing vehicle driving conditions. A vehicle may be more or less sensitive to the change in torque that the drive wheels undergo when the clutch is partially closed. Furthermore, the faster the clutch is closed, the higher will the derivative of the change in torque be. According to aspects of the invention, therefore, the prevailing vehicle driving condition is taken into account when determining the speed at which, and/or the degree to which, the clutch is closed during the acceleration of the internal combustion engine.

According to aspects of the invention the vehicle driving condition is determined based on one or more from the group: a weight of the vehicle, the speed at which, and/or the degree to which an accelerator pedal has been depressed, a torque request, a brake request, information related to the upcoming road ahead of the vehicle, and an available force that may be transferred between the vehicle and the road.

Variations in the driving conditions may be utilized to determine whether, and the extent to which, a torque is to be applied by the electric machine to compensate for torque applied to the internal combustion engine through partially closing the clutch.

For example, the clutch may be closed at a higher rate, and thereby faster apply a higher torque on the internal combustion engine, when the vehicle is heavily loaded and/or is being driven in non-slippery conditions. A heavily loaded vehicle will in general have a higher axle load and will thereby be less sensitive to the change in drive wheel torque, in particular when being driven on dry/high friction road. A higher torque may thereby be applied using the clutch. On the other hand, less torque may be applied for a more lightly loaded vehicle, and/or when the vehicle is driving in slippery conditions, where the use of the electrical machine may be particularly advantageous. The friction between the vehicle and road may be estimated, e.g., from ambient temperature, rain sensors and/or anti-lock brake systems or anti-skid systems, or information received from another vehicle or system.

Hence, parameters of this kind may be utilized to determine whether a torque is to be applied by the electric machine. The determination may also be based, e.g., on a current brake torque status, i.e., the extent to which the vehicle is currently being braked. In case the vehicle is already subjected to a high brake torque the clutch may be closed at a slower rate and/or to a lesser extent. Similarly, the topography of the road ahead may be taken into account, as well as other parameters. Also, the number of driven wheels of the vehicle may be taken into account, since more torque may be transferred between the road and the vehicle when the number of driven wheels is higher. The current gear ratio of a gearbox may also be used in the determination. Lower gears will in general give rise to higher impact on vehicle stability. The currently selected drive mode (e.g., eco mode, normal mode, power mode) may also be configured to influence the determination, where, e.g., a power mode may allow for a more aggressive start of the internal combustion engine by faster closing of the clutch.

Furthermore, in case the internal combustion engine is to be started, e.g., as a result of a driver depressing an accelerator, the speed at which, and magnitude to which, the clutch is closed may depend on the speed at which the accelerator is depressed, and/or the magnitude of the request for power. The determination may also be made based on a currently requested level of engine braking.

According to a further aspect, the invention relates to a control arrangement for starting an internal combustion engine, where the control arrangement is configured to effectuate acceleration of the internal combustion engine using drive wheel torque by partially closing the clutch to connect the internal combustion engine to the at least one first drive wheel and apply a vehicle propelling torque by the electric machine while accelerating the internal combustion engine. It will be appreciated that all the embodiments described for the method aspects of the invention are applicable also to control arrangement aspects of the invention. Thus, all the aspects described for methods according to the invention may be performed by the control arrangement, which may also be a control device, i.e., a device. The control arrangement and its embodiments have advantages corresponding to the advantages discussed above with regard to the various aspects of methods according to the invention.

According to another aspect of the invention, aforementioned and further objectives are achieved through a vehicle comprising a control arrangement according to aspects of the invention.

According to a further aspect, the invention relates to a computer program comprising instructions which, when the program is executed by a computer, cause the computer to carry out the method according to aspects of the invention.

According to an aspect, the invention relates to a computer-readable medium comprising instructions which, when executed by a computer, cause the computer to carry out the method according to aspects of the invention.

Further advantageous embodiments of the method, the control arrangement, the vehicle, the computer program, and the computer-readable medium according to the invention will emerge from the detailed description.

### BRIEF DESCRIPTION OF THE DRAWINGS

Embodiments of the invention will be illustrated in more detail below, along with the enclosed drawings, where similar references are used for similar parts, and where:

FIG. 1 shows a schematic view illustrating an exemplary vehicle in which aspects of the invention may be implemented;

FIG. 2 illustrates a prior art start of an internal combustion engine while the vehicle is in motion;

FIG. 3A shows a flow chart illustrating a method according to aspects of the invention;

FIG. 3B shows a flow chart illustrating methods according to further aspects of the invention;

FIG. 4 illustrates a start of an internal combustion engine according to aspects of the invention;

FIG. 5 illustrates a start of an internal combustion engine according to other aspects of the invention;

FIG. 6 illustrates a start of an internal combustion engine according to further aspects of the invention;

FIG. 7 shows a control arrangement, in which a method according to any one of the aspects described herein may be implemented.

### DETAILED DESCRIPTION

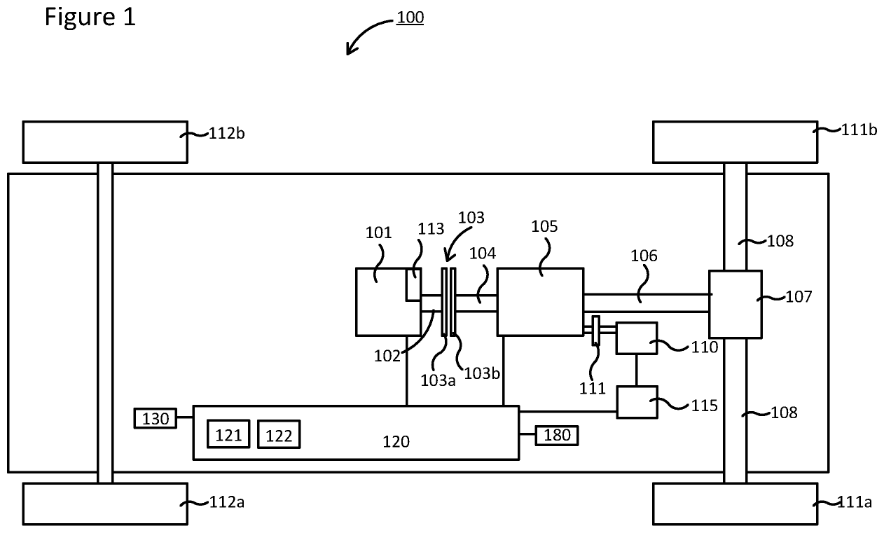

FIG. 1A schematically illustrates an exemplary powertrain of a vehicle 100 in which various aspects of the invention may be utilized. The vehicle 100 may, for example, be a heavy vehicle such a bus or a truck, or a passenger car.

The vehicle 100 comprises at least one drive wheel, e.g., a pair of drive wheels 111a, 111b as is illustrated in FIG. 1. The vehicle 100 is an electric hybrid vehicle, and comprises a powertrain configured to, inter alia, transfer torque between a power source in the form of an internal combustion engine (ICE) 101, and the drive wheels 111a, 111b. In this regard, an output shaft 102 of the ICE 101 may, in a manner known per se, be selectively connected to the drive wheels 111a, 111b. According to the example, the output shaft 102 of the ICE 101 is connected to a gearbox 105 through a clutch 103 having clutch plates 103a, 103b that selectively engages the ICE 101 by bringing the clutch plates 103a, 103b together to transmit torque through the clutch 103. An output shaft of the gearbox 105 is connected to the drive wheels 111a, 111b through a propeller shaft 106, a final gear 107, such as, e.g., a differential gear, and drive shafts 108.

In addition, the vehicle 100 comprises at least one electric machine 110, which may also be utilized to apply a propelling power to drive wheels 111a, 111b of the vehicle 100. According to the illustrated example, the electric machine 110 is illustrated as being connected to a layshaft (not shown) of the gearbox 105, although it is to be realized that the electric machine may be arranged essentially anywhere along the drive train as long as torque is provided to one or more of the wheels of the vehicle 100. In addition, there may be more than one electric machine present in the vehicle.

The electric machine is advantageously connectable to the drive wheels 111a, 111b to which the ICE 101 is connected, but this need not be the case, and, as will be explained, according to aspects of the invention the electric machine 110 is not connected to wheels being driven by the ICE 101. The at least one electric machine 110 may be provided with electric power from a power supply system 115 configured for powering the electric machine and thereby the vehicle 100. Such power supply systems may, for example, comprise a high voltage battery and/or constitute an external power supply such as a pantograph from an e-highway or inductive charging means in a manner known per se and therefore not described more in detail.

Furthermore, the electric machine 110 may be selectively connectable to the output shaft of the gearbox and/or the propeller shaft, and/or other suitable part of the gearbox such as a layshaft, through the use of a clutch 111. This allows, for example, that the electric machine 110 may be used for providing power to other functions of the vehicle 100 when not being used in the propulsion of the vehicle. For example, in addition to providing propelling power for propulsion of the vehicle, the ICE 101, in general, provides power to various other functions of the vehicle. Such functions may include, e.g., power steering and brake servo mechanisms. However, this is only possible when the ICE 101 is running since such functionality in general relies on a rotating output shaft of the ICE 101. According to aspects of the invention the electric machine may provide power for such functionality in place of the ICE when the ICE is shut off. The electric machine clutch 111 allows that such power may be provided without influencing the drivetrain of the vehicle 100. The configuration of FIG. 1 also allows regenerative braking independently from the current state of the ICE. However, it is to be understood that the configuration of FIG. 1 is only exemplary, and that the electrical machine may be arranged in any suitable manner, and may or may not be disconnectable from the vehicle wheels.

The drivetrain, including the electric machine 110 and power supply system 115, as well as other components of the powertrain may be controlled by a vehicle control system via a control arrangement 120 comprising control units 121, 122. The control arrangement 120 may, as is known per se, be distributed over a plurality of control units configured to control different parts of the vehicle 100. The illustration of FIG. 1 is hence only exemplary, and various other configurations exist.

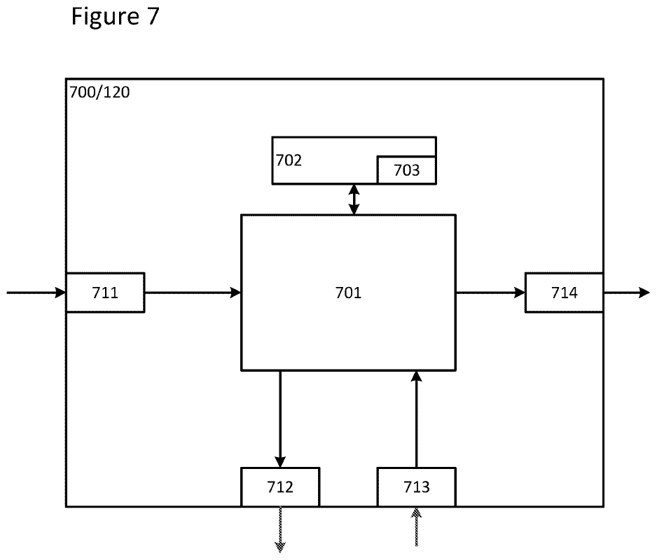

The control arrangement 120 and/or any other suitable control arrangement, may further be configured to control any other units/devices/entities of the vehicle 100. The control arrangement 120 will be described in further detail with reference to FIG. 7 below.

The vehicle 100 may also comprise a positioning system/unit. The positioning unit may be based on a satellite navigation system such as the Navigation Signal Timing and Ranging (Navstar), Global Positioning System (GPS), Differential GPS (DGPS), Galileo, GLONASS, or the like. Thus, the positioning unit 180 may comprise a GPS receiver. The positioning system may be utilized to determine prevailing and upcoming driving conditions of the vehicle.

The vehicle 100 may further include at least one communication device arranged for communication with at least one external entity, such as at least one communication entity of another vehicle. Correspondingly, the at least one communication device may be a vehicle-to-vehicle (V2V) communication device, a vehicle-to-infrastructure (V2I) communication device, a vehicle-to-everything (V2X) communication device, and/or a wireless communication device such that communication between the vehicle and the at least one external entity is achieved/provided. This may be utilized in various different ways, and according to aspects of the invention such communication may be utilized to determined prevailing and/or upcoming driving conditions of the vehicle.

It should also be understood that the powertrain of the vehicle 100 may be of various other different designs than the one illustrated in FIG. 1 without departing from the scope of the invention, for as long as an internal combustion engine is selectively connectable to drive wheels of the vehicles by means of a clutch, and an electric machine is capable of providing a propelling power to at least one drive wheel of the vehicle.

The vehicle 100 may further comprise one or more sensors 130, e.g., for measuring at least one parameter related to one or more vehicle operating conditions, where the sensors may be located at suitable positions within the vehicle 100. The one or more sensors 130 may be configured for communication with the control arrangement 120 to provide the control arrangement 120 with relevant information.

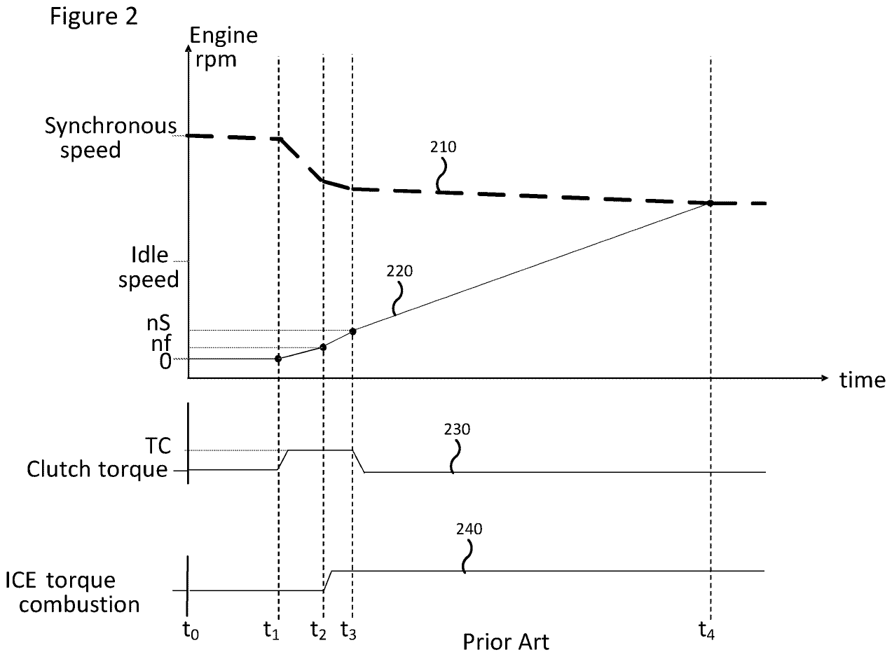

As was mentioned above, aspects of the invention provide a method for starting an internal combustion engine in an electric hybrid vehicle in a situation where the vehicle is in motion, and which method may reduce negative impacts of such engine starts. FIG. 2 illustrates a prior art example of a conventional method for starting an internal combustion engine in a situation when the vehicle is in motion, and which method may exhibit drawbacks that the invention may avoid or at least render less severe. In general, acceleration of the ICE using the clutch for startup purposes is possible when a vehicle is in motion.

The graph in the upper part of FIG. 2 illustrates, by dashed line 210, the synchronous speed of the internal combustion engine as a function of time. As is realized, the synchronous speed is dependent on the current speed of the vehicle, and will hence change as the speed of the vehicle changes. The synchronous speed of the ICE is also dependent on the current gear ratio of a gearbox when present, as is in general the case with regard to powertrains comprising an ICE acting on drive wheels of the vehicle.

According to the present description, it is assumed that the vehicle that is illustrated in FIG. 1 comprises a gearbox, and also that the gearbox is set to any suitable gear ratio. In particular, it is assumed that the gear ratio is not changed during the start of the ICE.

The solid line in the upper part of the graph of FIG. 2 illustrates the actual speed of the ICE, i.e. the speed of rotation of the output shaft of the ICE. The internal combustion engine is in a shut off state in the time interval between time t₀ and t₁, and the start of the ICE has not yet commenced. As can be seen from FIG. 2, the synchronous speed of rotation of the ICE is not constant but changes as time progress. According to the illustrated prior art example, the synchronous speed decreases only slightly between times t₀ and t₁, and the reason for this may, e.g., be that the vehicle is currently traveling on a road having an inclination being such that the vehicle speed slightly reduces, e.g. in a situation where the vehicle is freewheeling.

At time t₁, or at some point prior to time t₁, it is determined that the ICE is to be started, e.g., due to a foreseen upcoming increased demand for propulsion power or for any other suitable reason, such as for providing power to vehicle on-board equipment. At time t₁ the start of the ICE is commenced by partially closing the clutch. This is illustrated in the middle graph of FIG. 2 by the corresponding change in clutch torque 230 as a function of time, i.e., torque being transmitted by the clutch. At time t₁ a closing of the clutch is commenced so that a clutch torque TC is transmitted between the vehicle drive wheels and the ICE. This torque TC, which hence emanates from the drive wheels, will accelerate the output shaft of the ICE.

This is illustrated in the figure by solid line 220 in the upper graph, where the speed of rotation of the ICE starts to increase from zero at time t₁. Following a certain period of time, and/or when the speed of rotation of the ICE has reached a predetermined speed of rotation nf, fuel injection is commenced and the ICE starts to produce torque, time t₂. Following a further period of time, and/or when the ICE has reached a speed of rotation nS at which the ICE is considered to be capable of accelerating by itself, time t₃, the clutch is again opened. The ICE will then accelerate to idle speed at which the ICE, in general, is considered to be started, and, according to the present example, further to the synchronous speed, which according to the present example is higher than the idle speed, through appropriate fuel injection. The synchronous speed is reached at time t₄, after which, e.g., the clutch may be fully closed and the vehicle be propelled by the ICE.

With further regard to the synchronous speed, it can be noted from FIG. 2 that between times t₁ and t₂ there is a substantial drop in the synchronous speed followed by a further, albeit less abrupt, drop in speed between times t₂ and t₃, after which the decrease in speed again continues to decrease in a manner more similar to the situation that prevailed between times t₀ and t₁. The, relatively substantial, drop in speed of rotation that occurs between times t₁ and t₂ is caused by the consumption of drive wheel torque when the clutch is partially closed. That is, the ICE will act as a brake that decelerates the vehicle. The reduction in the synchronous speed is less steep between times t₂ and t₃. This is because the torque consumed for accelerating the ICE is partly provided for by the torque 240 that the ICE generates by itself through combustion of fuel when fuel injection has commenced. When the clutch is again opened, at time t₃, the reduction in synchronous reverts to the situation prevailing between t₀ and t₁, and at t₄, when the speed of rotation of the ICE has reached synchronous speed, the clutch may be closed to allow the vehicle to be propelled by the ICE. This, however, is not illustrated in the figure.

However, the change in applied torque that the vehicle drive wheels undergo when the ICE is accelerated using the clutch may, as discussed, have a destabilizing impact on the vehicle. For example, if the vehicle is being driven in slippery and/or wet conditions a sudden change in drive wheel torque, which will be perceived as a sudden brake action, may cause the vehicle to suddenly skid, or otherwise have a negative impact on the driving of the vehicle. This may be highly uncomfortable for the driver and possible passengers in the vehicle, in particular in case the start of the ICE occurs at a point in time when this is not expected. This may also give rise to potentially hazardous situations, for example if the vehicle is currently being driven downhill, or is being driven on a curvy road.

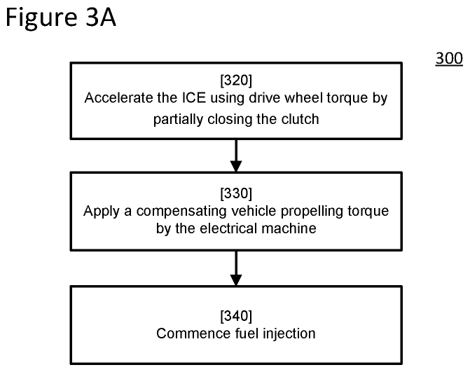

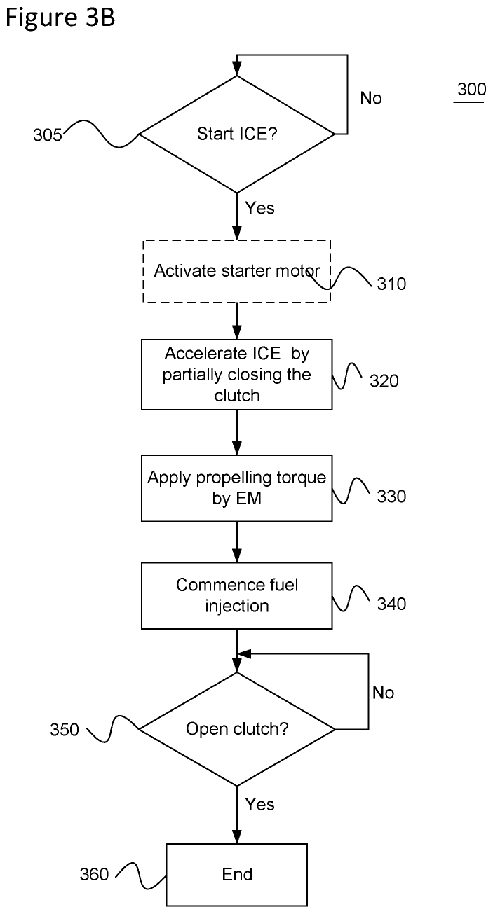

According to aspects of the invention, problems of this kind are at least mitigated, and aspects of the invention will now be described with reference to a method 300, schematically illustrated in FIG. 3A. The method 300 may be carried out by any one or more suitable control arrangements of the vehicle, such as the control arrangement 120.

The method comprises, step 320, for at least one first vehicle driving condition, when the internal combustion engine 101 is disconnected from the at least one first drive wheel 111a, 111b, and is to be started when the vehicle 100 is in motion, accelerating the internal combustion engine 101 using drive wheel torque by partially closing the clutch 103 to connect the internal combustion engine 101 to the at least one first drive wheel 111a, 111b. This step is hence similar to the prior art solution of FIG. 2. However, in order to mitigate the problems described above, aspects of the invention comprise applying a compensating vehicle propelling torque by the electric machine 110 while accelerating the internal combustion engine 101, step 330. The method also comprises commencing fuel injection to start the internal combustion engine 101, step 340 to start the ICE.

It is to be understood that the method steps 320-340 need not be performed consecutively, but may be commenced in any suitable order, and be carried out partly or fully simultaneously, for as long as the electric machine applies a compensating vehicle propelling power at least partly overlapping with the time that the clutch is at least partially closed and torque is provided by the drive wheels. The torque applied by the electric machine will at least partly compensate for the loss in drive wheel torque that is used to accelerate the internal combustion engine. In this way, the negative impact that the brake torque from starting the internal combustion engine using the clutch has on the driving of the vehicle may be partly or fully mitigated. As a result, the risk of, e.g., vehicle instability may be reduced.

Aspects of the invention will be explained more in the detailed with reference to figure 3B and FIGS. 4-6.

FIG. 3B illustrates an exemplary method 300 according to aspects of the invention. The method 300 starts in step 305, where it is determined whether to start the ICE 101 in a situation where the ICE 101 is disconnected from the vehicle drive wheels and the vehicle is in motion. This determination may consist of an indication that the ICE 101 is to be started, where the indication may be received from any other suitable part of the vehicle control system which may be configured to perform the actual determination. When the ICE 101 is to be started, the method continues to step 320 (optional step 310 will be discussed further below), which is similar to step 320 in FIG. 3A, and where hence the clutch 103 is partially closed.

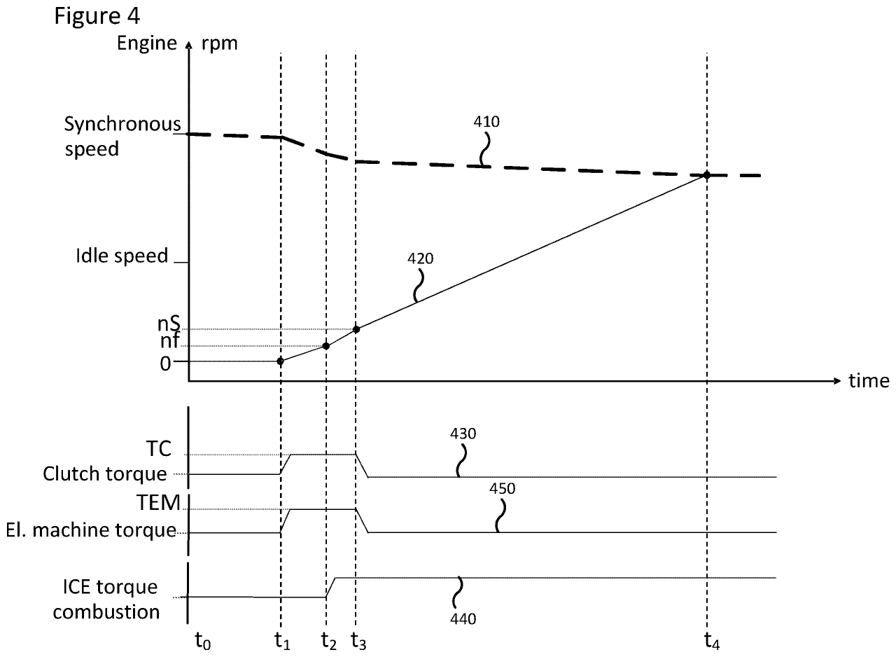

This is illustrated in FIG. 4, which illustrates a situation similar to FIG. 2 but where in addition to what is illustrated in FIG. 2, FIG. 4 also illustrates electric machine torque 450 in the lower part of the figure. Also similar to FIG. 2, the ICE is in a shut off state between times t₀ and t₁. At time t₁, or at some point in time before time t₁, it is determined, step 305 of FIG. 3B, that the ICE is to be started. The clutch 103 is then partially closed, step 320, to apply a clutch torque TC on the output shaft of the ICE 101 in order to accelerate the ICE 101 from standstill. However, in addition to this, a torque TEM is simultaneously applied by the electric machine 110 to compensate for the torque TC that is transmitted by the clutch 103, and the torque TEM may be controlled to fully or partly correspond to the clutch torque TC.

Hence, similar to FIG. 2, the ICE 101 will begin to accelerate at time t₁. However, in difference to the solution of FIG. 2, since the torque TEM applied by the electric machine 110 may partly or fully compensate for the clutch torque TC, the influence as exhibited in terms of a change in vehicle speed, and thereby synchronous speed of the ICE, may be considerably less in comparison to the solution of FIG. 2. This is also illustrated by the dashed line 410 in FIG. 4, where the vehicle 100 is affected to a lesser extent than is the case illustrated in FIG. 2. This, in turn, may increase driver comfortability, and, in particular, vehicle stability when the electric machine 110 applies the torque TEM to the same wheel or wheels that are normally driven by the ICE 101 and presently accelerating the ICE. The use of the electric machine may also provide for a more rapid start of the ICE. Following the steps 320, 330, fuel injection is commenced at time t₂, step 340.

In step 350 it is determined whether the clutch 103 is again to be opened, and the method remains in step 350 for as long as this is not the case. According to the example illustrated in FIG. 4, the clutch 103 is maintained partially closed until time t₃, where it is determined that the clutch 103 is again to be opened. This may be the case, e.g., following a certain period of time and/or when the speed of rotation of the ICE 101 has reached a predetermined speed threshold, such as speed nS in FIG. 4. Similarly, the torque TEM applied by the electric machine 110 may be reduced when the clutch 103 is opened in step 350. The speed reduction that the vehicle undergoes between times t₂ and t₃ will hence also occur to a lesser extent when compared to FIG. 2. Fuel injection may be commenced at any suitable point in time, for example between time t₁ and t₂, and/or at a particular speed of rotation of the ICE 101, with the result that the ICE 101 also starts producing torque that will help accelerate the ICE 101 as described above. For example, fuel injection may be configured to commence at a speed of rotation nf where the fuel will in fact ignite and produce torque. Also, the lower the speed of rotation is of the ICE when fuel injection is commenced, the more vibrations will arise. It may hence be advantageous to commence fuel injection at a higher speed of rotation than the speed of rotation where the ICE starts to produce torque. Alternatively, the injection of fuel may, instead, be configured to be commenced, e.g., as soon as the ICE 101 starts accelerating.

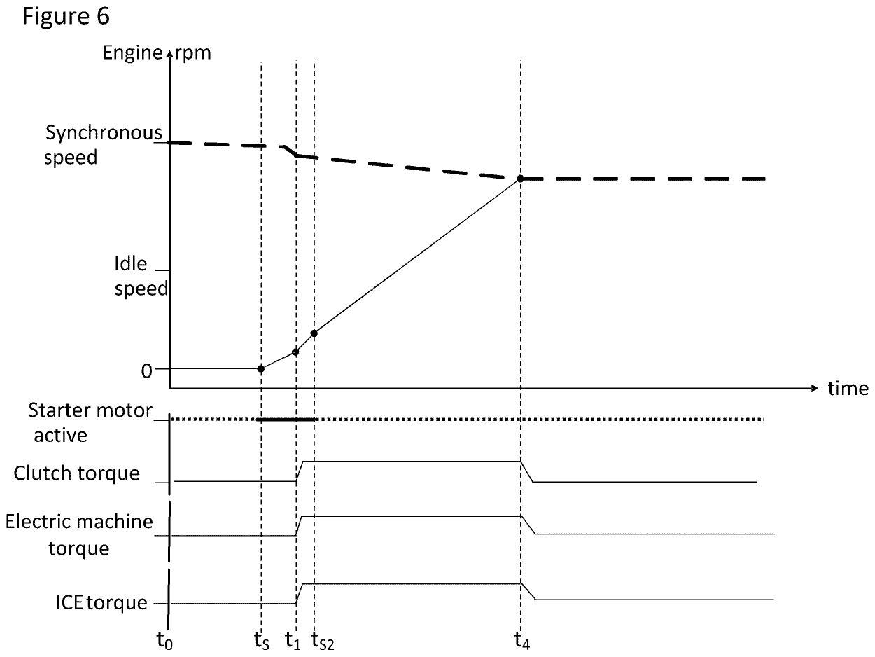

Further, as is known to the person skilled in the art, the clutch 103 is normally subjected to wear when there is a difference in speed of rotation between the clutch plates 103a, 103b. The wear is, in general, dependent on the magnitude of the difference in speed of rotation between the clutch plates 103a, 103b, and since the difference in speed of rotation is high when the starting of the ICE 101 is commenced, the clutch wear may also be high. The time during which the clutch is partially closed when starting the ICE 101 may therefore be determined, e.g., in terms of expected wear. However, it is contemplated, and also illustrated in FIG. 6 as described below, that the clutch 103 may be maintained partially closed for longer periods of time than what is illustrated in FIG. 4. For example, the clutch 103 may be configured to be partially closed during any suitable time, including throughout the acceleration of the ICE 101 to the synchronous speed.

It is further to be noted that although it may prove beneficial that the compensating torque TEM being applied by the electric machine 110 corresponds to the torque TC being transmitted by the clutch, the electric machine 110 may be controlled to apply any suitable torque, such as any suitable fraction of the torque TC being transmitted by the clutch. It is also to be noted that the torque TEM that is applied by the electric machine 110 according to the invention is a relative change in torque. That is, in case the electric machine 110 is already applying a torque to the drive wheels prior to the ICE 101 is to be started, this torque is changed by the addition of the torque TEM.

Hence, in case the electric machine 110 is already providing a propelling torque, this propelling torque may be increased by the torque TEM. On the other hand, in case the electric machine 110 is providing a brake (negative) torque, this will also be accounted for when determining the torque to be applied by the electric machine 110, where the resulting torque may still be a, albeit lower, brake torque.

The method of FIG. 3B may be configured to be carried out only when certain vehicle driving conditions prevail and, also, the rate at which, and/or the degree to which, the clutch 103 is closed when accelerating the internal combustion engine may be based on the vehicle driving condition. For example, the clutch may be closed at a higher rate, and/or apply a higher torque TC on the internal combustion engine 101 when conditions are favorable, such as when the vehicle is heavily loaded on level road and/or is travelling in non-slippery conditions.

Various different parameters may be utilized to determine the vehicle driving conditions, and in addition to, e.g., vehicle weight and road conditions a current torque or brake request may also be utilized in the determination of torque to be applied by the electric machine, and the degree to which the clutch is to be closed. For example, the clutch may be closed to a lesser extent if the vehicle currently is braking with a high brake torque. Information related to the upcoming road ahead of the vehicle may also be utilized, where e.g., curvature and road gradient may be used in the determination. The friction between the vehicle and road may also be estimated, e.g., from ambient temperature, rain sensors and/or anti-lock brake systems or anti-skid systems.

With further regard to the illustrated example, it is to be understood that the electric machine 110 need not necessarily apply the power TEM to the same wheels 111a, 111b that are connected to the ICE 101. The electric machine 110 may, instead, be connected to one or more wheels that are different from the one or more wheels that are driven by the ICE 101, such as wheels 112a, 112b in FIG. 1. A solution of this kind will still provide advantages with regard to driver comfortability, e.g., in terms of the lesser speed reduction that the vehicle undergoes during the start of the ICE 101, but may not provide the same advantages with regard to vehicle stability. The vehicle may, furthermore, comprise a tractor unit and a trailer, and as a further alternative to providing torque to tractor unit wheels that are different from the one or more wheels that are driven by the ICE 101 the electric machine may be configured to provide power to wheels of the trailer.

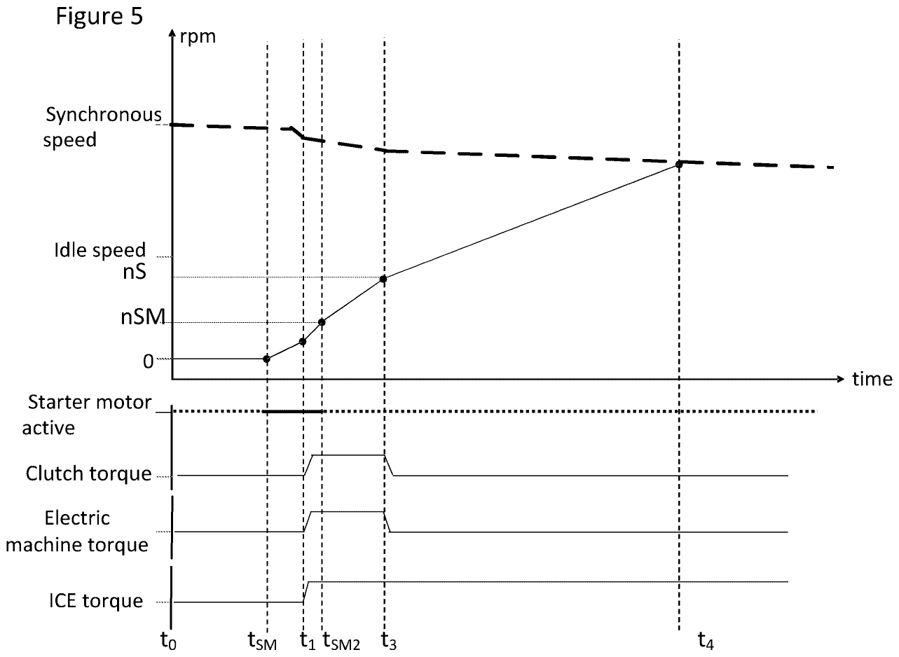

FIG. 5 illustrates a further exemplary embodiment according to aspects of the invention. The method according to FIG. 5 is, to a large extent, similar to the method illustrated in FIG. 4. However, the method illustrated in FIG. 5 differs from FIG. 4 in that the starter motor 113 is activated at the time tSM prior to partially closing the clutch 103. This is step is schematically indicated in the method of FIG. 3B by optional step 310. Following the activation of the starter motor 113 the clutch 103 is partially closed at time t₁. The electric machine 110 is also controlled to apply a propelling torque TEM and fuel injection is commenced. The activation of the starter motor 113 is maintained until a time tSM2, where the speed of rotation of the ICE has reached a speed of rotation nSM at which the use of the starter motor is stopped. The start of the ICE is then completed in a manner similar to what is shown in FIG. 4 but where, according to the present example, the ICE may reach a higher speed of rotation nS prior to again opening the clutch 103. The solution according to FIG. 5 further reduces the decrease in speed that the vehicle undergoes during the start of the ICE, which may further reduce the risk for vehicle instability and increased driver comfortability. The method according to FIG. 5 may further include a step of certifying that the output shaft of the ICE 101 is standing still prior to activating the starter motor 113 in order to reduce the risk of subjecting the starter motor 113 to excess wear.

FIG. 6 illustrates another embodiment according to aspects of the invention. The embodiment of FIG. 6 is similar to the embodiment of FIG. 5 with regard to the activation and the activation of the starter motor, the partial closing of the clutch and the commencement of the applying of electric machine torque. The method of FIG. 6, however, differs from FIG. 5 in that the clutch is maintained partially closed throughout the start of the ICE, and further maintained partially closed until the speed of rotation of the ICE has reached the synchronous speed at time t₄. Similarly, a vehicle propelling torque is applied by the electric machine during this time. At time t₄ the clutch 103 is again opened, or alternatively fully closed to allow the ICE to propel the vehicle. The electric machine torque may also be reduced, and the and the ICE torque may be reduced to a torque sufficient to maintain the desired speed of rotation, or be increased in case a vehicle propelling power is to be provided. It is to be understood that various scenarios may take place at time t₄.

According to embodiments of the invention, the electric machine may be positioned upstream the clutch 103, i.e., be connected directly to the output shaft of the ICE. This will reduce the amount of torque that needs to be transmitted over the clutch when starting the ICE, since part of the torque may be provided by the electric machine directly. This may reduce wear of the clutch. Alternatively, the total torque being applied to the ICE may be increased since the torque applied by the electric machine may be added to the torque transmitted over the clutch. This may provide for an even more rapid start of the ICE.

In sum, according to various aspects of the invention, it is provided methods for starting an ICE in an electric hybrid vehicle in a situation where the vehicle is in motion that may reduce the possibility of vehicle instability from occurring during the start and which methods may also increase driver comfortability.

According to an aspect of the invention, a control arrangement 120 for starting an internal combustion engine in a vehicle 100 comprising an electric machine 110 configured to apply a propelling power to the vehicle 100 is provided.

The control arrangement 120, includes a control unit 121 arranged to, in a situation where the vehicle is in motion, accelerate the ICE using drive wheel torque by partially closing the clutch. Furthermore the, the control arrangement 120 includes a control unit 122 arranged to apply a vehicle propelling torque by the electric machine while accelerating the internal combustion engine using drive wheel torque, so as to at least partly compensate for drive wheel torque being used to accelerate the internal combustion engine. The control arrangement 120, e.g. a device or a control device, according to the invention may be configured to perform all aspects that have been described with regard to methods.

Hence the control arrangement 120 is provided with the above-described advantages for the various aspects of the invention. The invention also relates to a vehicle 100 including the control arrangement 120.

FIG. 7 illustrates a control arrangement 700/120, which may be utilized to carry out the invention. The control arrangement 700/120 comprises a computing unit 701, which can be constituted by essentially any suitable type of processor or microcomputer, e.g., a circuit for digital signal processing (Digital Signal Processor, DSP), or a circuit having a predetermined specific function (Application Specific Integrated Circuit, ASIC). The computing unit 701 is connected to a memory unit 702 arranged in the control arrangement 700/120, which memory unit provides the computing unit 701 with, e.g., the stored program code and/or the stored data which the computing unit 701 requires to be able to perform computations. The computing unit 701 is also arranged to store partial or final results of computations in the memory unit 702.

In addition, the control arrangement 700/120 is provided with devices 711, 712, 713, 714 for receiving and transmitting input and output signals. These input and output signals can contain waveforms, impulses, or other attributes which, by the devices 711, 713 for the reception of input signals, can be detected as information and can be converted into signals which can be processed by the computing unit 701. These signals are then made available to the computing unit 701. The devices 712, 714 for the transmission of output signals are arranged to convert signals received from the computing unit 701 in order to create output signals by, e.g., modulating the signals, which can be transmitted to other parts of and/or systems in the vehicle 100.

Each of the connections to the devices for receiving and transmitting input and output signals can be constituted by one or more of a cable; a data bus, such as a Controller Area Network CAN bus, a Media Orientated Systems Transport MOST bus, or some other bus configuration; or by a wireless connection. A person skilled in the art will appreciate that the above-stated computer can be constituted by the computing unit 701 and that the above-stated memory can be constituted by the memory unit 702.

Control systems in modern vehicles commonly comprise communication bus systems consisting of one or more communication buses for linking a number of electronic control units, ECU's, or controllers, and various components located on the vehicle. Such a control system can comprise a large number of control units and the responsibility for a specific function can be divided amongst more than one control unit. Vehicles of the shown type thus often comprise significantly more control units than are shown in FIGS. 1 and 7, which is well known to the person skilled in the art within this technical field.

In a shown embodiment, the invention may be implemented by the one or more above mentioned control units 121 and 122. The invention can also, however, be implemented wholly or partially in one or more other control units being present in the vehicle 100, or in one or more control unit dedicated to the invention.

Here and in this document, units are often described as being arranged for performing steps of the method according to the invention. This also includes that the units are designed to and/or configured to perform these method steps.

The control units 121 and 122 are in FIG. 1 illustrated as forming part of one unit. These and other units may, however, be logically separated but physically implemented in the same unit or can be both logically and physically arranged together. These units may, e.g., correspond to groups of instructions, which can be in the form of programming code, that are input into, and are utilized by a processor/computing unit 601 when the units are active and/or are utilized for performing its method step, respectively.

The person skilled in the art will appreciate that the embodiments described herein for starting an internal combustion engine may also be implemented in a computer program, which, when it is executed in a computer, instructs the computer to execute the method. The computer program is usually constituted by a computer program product 703 stored on a non-transitory/non-volatile digital storage medium, in which the computer program is incorporated in the computer-readable medium of the computer program product. The computer-readable medium comprises a suitable memory, such as, e.g.: Read-Only Memory ROM, Programmable Read-Only Memory PROM, Erasable PROM EPROM, Flash memory, Electrically Erasable PROM EEPROM, a hard disk unit, etc.

Finally, the invention is not limited to the above-described embodiments, but the invention relates to, and encompasses, all of the different embodiments that are included within the scope of the independent claims.

1. A method performed by a control arrangement for starting an internal combustion engine in an electric hybrid vehicle, the internal combustion engine configured for applying a propelling torque to at least one first drive wheel of the vehicle, the vehicle comprising: a clutch selectively connecting an output shaft of the internal combustion engine to the at least one drive wheel of the vehicle; and an electric machine for applying a propelling torque to the at least one first or at least one second drive wheel of the vehicle,
the method comprising, for at least one first vehicle driving condition, when the internal combustion engine is disconnected from the at least one first drive wheel, and is to be started when the vehicle is in motion:
accelerating the internal combustion engine using drive wheel torque by partially closing the clutch to connect the internal combustion engine to the at least one first drive wheel;
applying a vehicle propelling torque by the electric machine while accelerating the internal combustion engine, so as to at least partly compensate for drive wheel torque being used to accelerate the internal combustion engine; and
commencing fuel injection to start the internal combustion engine.

2. A method according to claim 1, further comprising:
commencing an applying of torque to the internal combustion engine by means of a starter motor prior to partially closing the clutch to connect the internal combustion engine to the at least one first drive wheel; and
commencing fuel injection prior to or following the clutch partially being closed.

3. A method according to claim 1, further comprising:
commencing the fuel injection for starting the internal combustion engine when a speed of rotation of the internal combustion engine has reached a first speed of rotation.

4. A method according to claim 1, further comprising:
maintaining the clutch partially closed until a speed of rotation of the output shaft of the internal combustion engine corresponds to a predetermined speed of rotation, the predetermined speed of rotation being a speed of rotation below a speed of rotation of the clutch caused by the at least one first drive wheel; and
opening the clutch when the predetermined speed of rotation has been reached.

5. A method according to claim 1 further comprising:
maintaining the clutch partially closed until a speed of rotation of the output shaft of the internal combustion engine corresponds to a speed of rotation of the clutch caused by the at least one first drive wheel.

6. A method according to claim 1, further comprising:
applying the vehicle propelling torque by the electric machine while the clutch is partially closed.

7. A method according to claim 1, further comprising:
the electric machine applying the vehicle propelling torque to a shaft being propelled by the internal combustion engine when connected to the at least one first drive wheel by means of the clutch.

8. A method according to claim 1, further comprising:
the electric machine applying the vehicle propelling torque to at least one drive wheel being different from the at least one first drive wheel.

9. A method according to claim 1, wherein:
a speed at which, and/or a degree to which, the clutch is closed during an acceleration of the internal combustion engine is at least partly based on the vehicle driving condition.

10. A method according to claim 1, the vehicle further comprising a gearbox connecting the internal combustion engine to the at least one first drive wheel, the method comprising:
accelerating the internal combustion engine when a gear is engaged in the gearbox.

11. A method according to claim 1, wherein the vehicle driving condition is determined based on one or more from the group:
a weight of the vehicle,
a speed at which, and/or a degree to which an accelerator pedal has been depressed,
a torque request,
a brake request,
information related to an upcoming road ahead of the vehicle, and
an available force that may be transferred between the vehicle and the road.

12. A control arrangement for starting an internal combustion engine in an electric hybrid vehicle, the internal combustion engine configured for applying a propelling torque to at least one first drive wheel of the vehicle, the vehicle comprising: a clutch selectively connecting an output shaft of the internal combustion engine to the at least one drive wheel of the vehicle; and an electric machine for applying a propelling torque to the at least one first or at least one second drive wheel of the vehicle,
the control arrangement configured to, for at least one first vehicle driving condition, when the internal combustion engine is disconnected from the at least one first drive wheel, and is to be started when the vehicle is in motion:
accelerate the internal combustion engine using drive wheel torque by partially closing the clutch to connect the internal combustion engine to the at least one first drive wheel;
apply a vehicle propelling torque by the electric machine while accelerating the internal combustion engine, so as to at least partly compensate for drive wheel torque being used to accelerate the internal combustion engine; and
commence fuel injection to start the internal combustion engine.

13. A vehicle comprising:
an internal combustion engine configured for applying a propelling torque to at least one first drive wheel of the vehicle;
a clutch selectively connecting an output shaft of the internal combustion engine to the at least one drive wheel of the vehicle;
an electric machine for applying a propelling torque to the at least one first or at least one second drive wheel of the vehicle; and
a control arrangement configured to, for at least one first vehicle driving condition, when the internal combustion engine is disconnected from the at least one first drive wheel, and is to be started when the vehicle is in motion:
accelerate the internal combustion engine using drive wheel torque by partially closing the clutch to connect the internal combustion engine to the at least one first drive wheel;
apply a vehicle propelling torque by the electric machine while accelerating the internal combustion engine, so as to at least partly compensate for drive wheel torque being used to accelerate the internal combustion engine; and
commence fuel injection to start the internal combustion engine.

14. A computer program product stored on a non-transitory computer-readable medium, said computer program product for starting an internal combustion engine in an electric hybrid vehicle, the internal combustion engine configured for applying a propelling torque to at least one first drive wheel of the vehicle, the vehicle comprising: a clutch selectively connecting an output shaft of the internal combustion engine to the at least one drive wheel of the vehicle; and an electric machine for applying a propelling torque to the at least one first or at least one second drive wheel of the vehicle, wherein said computer program product comprising computer instructions to cause a control arrangement to perform the following operations for at least one first vehicle driving condition, when the internal combustion engine is disconnected from the at least one first drive wheel, and is to be started when the vehicle is in motion:
accelerate the internal combustion engine using drive wheel torque by partially closing the clutch to connect the internal combustion engine to the at least one first drive wheel;
apply a vehicle propelling torque by the electric machine while accelerating the internal combustion engine, so as to at least partly compensate for drive wheel torque being used to accelerate the internal combustion engine; and
commence fuel injection to start the internal combustion engine.

15. (canceled)
